(19) United States
(12) Patent Application Publication
(10) Pub. No.: US 2025/0044453 A1
(43) Pub. Date: Feb. 6, 2025

(54) 3D SUB-GRID MAP-BASED ROBOT POSE ESTIMATION METHOD AND ROBOT USING THE SAME

(71) Applicant: TWINNY CO., LTD., Daejeon (KR)

(72) Inventor: Jun Hyung KIM, Goyang-si (KR)

(73) Assignee: TWINNY CO., LTD., Daejeon (KR)

(21) Appl. No.: 18/923,186

(22) Filed: Oct. 22, 2024

Related U.S. Application Data
(63) Continuation of application No. PCT/KR2024/007888, filed on Jun. 10, 2024.

(30) Foreign Application Priority Data
Jun. 14, 2023 (KR) 10-2023-0076061

(51) Int. Cl. G01S 17/89; G01S 17/933; G06T 7/33; G06T 7/73

(52) U.S. Cl. CPC G01S 17/89; G01S 17/933; G06T 7/33; G06T 7/73; G06T 2207/10028; G06T 2207/20076; G06T 2207/30261

(57) ABSTRACT

Embodiments relate to a method and a robot for estimating a pose, and the robot estimating the pose using a 3-dimensional (3D) sub-grid map includes a main body part, a transfer part configured to move the main body under the control of the main body part, and a light detection and ranging (LiDAR) part configured to emit light and detect reflected light from objects in a global space to generate and transmit LiDAR scan data to the main body part, wherein the main body part includes a personal computer (PC) estimating the position and orientation of the mobile robot, the PC including a LiDAR scan data acquisition module configured to acquire LiDAR scan data for each sub-grid of a 3D grid map based on the robot, a particle generation module configured to generate robot candidate particles on the global map, a LiDAR scan data transformation module configured to transform the LiDAR scan data acquired by the LiDAR scan data acquisition module based on the pose of the robot to the pose of particles generated by the particle generation module, and a sub-grid projection module configured to display the transformed LiDAR scan data from the LiDAR scan data transformation module onto the 3D sub-grid based on the robot.

### TECHNICAL FIELD

An embodiment of the present invention relates to a method for estimating the pose of a robot, which is composed of position and orientation, and a robot capable of estimating the pose using the same, and more particularly, to a method for estimating the pose in a 3-dimensional (3D) space and a robot.

### BACKGROUND ART

With the recent advancements in various fields of technology such as AI, motion control, and object recognition, the use of robots, which were traditionally used mainly in industrial settings, has expanded to include restaurants, large stores, logistics centers, and other areas, making it common to encounter robots in our daily surroundings.

These robot-based services are still predominantly used indoors due to control and safety issues, and accurate position and orientation estimation is essential for indoor mobile robot services. To continuously estimate the position of a mobile robot, it is crucial to accurately determine its initial position, and a common method for achieving this is scan matching.

Conventional scan matching involves acquiring various related information such as image data, depth maps, point cloud maps, repositioning poses, and repositioning variances (S1), obtaining the 3D coordinates of spatial obstacle points based on the depth map (S2), acquiring target poses and environmental 3D coordinates corresponding to the target poses based on repositioning pose, repositioning variances, and point cloud maps (S3), performing scan matching between the 3D coordinates of spatial obstacle points and environmental 3D coordinates to obtain matching result information (S4), and obtaining positioning information based on repositioning poses and repositioning variances if the matching result information meets preset conditions (S5), thereby acquiring location information for robots and other devices by scan matching the 3D coordinates of spatial obstacle points with environmental 3D coordinates.

However, such scan matching-based algorithms have a high computational load and are prone to predicting incorrect positions when there is a shortage of point cloud data obtained in the form of light detection and ranging (LiDAR) data or when there are significant changes in the environment between the creation of the depth map and the robot's navigation.

To address the shortcomings of scan matching-based localization methods, the grid map-based Monte Carlo localization algorithm can be used; however, due to high computational requirements and large memory usage, traditional grid map-based localization using LiDAR data has limited the Monte Carlo localization algorithm to 2-dimensional (2D) grid maps.

With the increasing utilization of devices navigating in 3D space like drones, the demand for position estimation in 3D space has risen; however, directly applying the Monte Carlo localization algorithm to 3D space results in significantly increased computational requirements, posing challenges for real-time position estimation and requiring expensive memory and CPU resources.

### DISCLOSURE

### Technical Problem

The embodiments of the present invention have been conceived to solve the above problems and aim to provide a method and robot capable of performing Monte Carlo localization algorithm in 3D space while reducing computational requirements.

The objects of the present invention are not limited to the aforesaid, and other objects not described herein will be clearly understood by those skilled in the art from the descriptions below.

### Technical Solution

A robot estimating the pose thereof using a 3-dimensional (3D) sub-grid map according to the present invention includes a main body part comprising a control device configured to estimate position and orientation, a transfer part configured to move the main body under the control of the main body part, and a light detection and ranging (LiDAR) part configured to emit light and detect reflected light from objects in a global space to generate and transmit LiDAR scan data to the main body part, wherein the main body part includes a personal computer (PC) estimating the position and orientation of the mobile robot, the PC including a LiDAR scan data acquisition module configured to acquire LiDAR scan data for each sub-grid of a 3D grid map based on the robot, a particle generation module configured to generate robot candidate particles on the global map, a LiDAR scan data transformation module configured to transform the LiDAR scan data acquired by the LiDAR scan data acquisition module based on the pose of the robot to the pose of particles generated by the particle generation module, a sub-grid projection module configured to display the transformed LiDAR scan data from the LiDAR scan data transformation module onto the 3D sub-grid based on the robot, a weight assignment module configured to assign weight proportional to the similarity between the pose of each particle and the pose of the robot, a particle filtering module configured to retain a predetermined number or proportion of particles, among the particles generated by the particle generation module, based on the weights assigned by the weight assignment module, a robot pose estimation module configured to estimate the pose of the robot based on the poses of the filtered particles from the particle filtering module, and a pose change determination module configured to determine whether the pose of the robot has changed, triggering a re-estimation the pose of the robot, and upon the pose change determination module determining a change in the pose of the robot, the LiDAR scan data acquisition module, particle generation module, LiDAR scan data transformation module, sub-grid projection module, weight assignment module, particle filtering module, and robot pose estimation module repeat the respective operations thereof.

A 3-dimensional (3D) sub-grid map-based robot pose estimation method according to the present invention includes acquiring LiDAR scan data for each sub-grid of a 3D grid map based on the robot, generating robot candidate particles on the global map, transforming the LiDAR scan data acquired by the LiDAR scan data acquisition module based on the pose of the robot to the pose of particles generated by the particle generation module, displaying the transformed LiDAR scan data from the LiDAR scan data transformation module onto the 3D sub-grid based on the robot, assigning weight proportional to the similarity between the pose of each particle and the pose of the robot, retaining a predetermined number or proportion of particles, among the particles generated by the particle generation module, through filtering based on the weights assigned by the weight assignment module, and re-estimating the pose of the robot based on the poses of the filtered particles from the particle filtering module, determining whether the pose of the robot has changed, triggering a re-estimation the pose of the robot, and upon determining a change in the pose of the robot, repeating acquiring LiDAR scan data, generating robot candidate particles, transforming the LiDAR scan data, displaying the transformed LiDAR scan data, assigning weight, retaining a predetermined number or proportion of particles through filtering, and estimating the pose of the robot.

### Advantageous Effects

According to the present invention, the 3D sub-grid map-based robot pose estimation method and a robot using the same is advantageous in terms of significantly reducing computational cost of 3D pose estimation by performing computations within a 3D sub-grid centered around the robot. This enables real-time pose estimation on low-performance personal computers (PCs).

Furthermore, it is advantageous to filter residual particles by considering the probability of static obstacles in the 3D sub-grid where both raw and transformed LiDAR scan data belong in terms of reducing the likelihood of pose estimation errors caused by dynamic obstacles.

The effects of the present invention are not limited to the aforesaid, and other effects not described herein with will be clearly understood by those skilled in the art from the claims.

### DESCRIPTION OF DRAWINGS

FIG. 1 is a flowchart illustrating a method for estimating position using scan matching;

FIG. 2 is a conceptual diagram of a global map;

FIG. 3 is a conceptual diagram of a 3D sub-grid map;

FIG. 4 is a diagram illustrating creation of a 3D sub-grid map;

FIG. 5 is a diagram illustrating the overlapping state of a global map and a 3D sub-grid map;

FIG. 6 is a diagram illustrating the 3D sub-grid map in FIG. 5 and map points included therein;

FIG. 7 is a perspective view of a robot capable of pose estimation using a 3D sub-grid map according to the present invention;

FIG. 8 is a block diagram of a robot capable of pose estimation using a 3D sub-grid map according to the present invention;

FIG. 9 is a block diagram of a module assembly for estimating the pose of a robot on a PC;

FIG. 10 is a flowchart of a pose estimation method performed in each module;

FIG. 11 is a diagram illustrating the distribution of particles initially generated in the absence of any prior information;

FIG. 12 is a diagram illustrating the distribution of particles initially generated with prior information;

FIG. 13 is a diagram illustrating LiDAR scan data acquired from a robot and transformed LiDAR scan data based on particles; and

FIG. 14 is a diagram illustrating sub-grid projection.

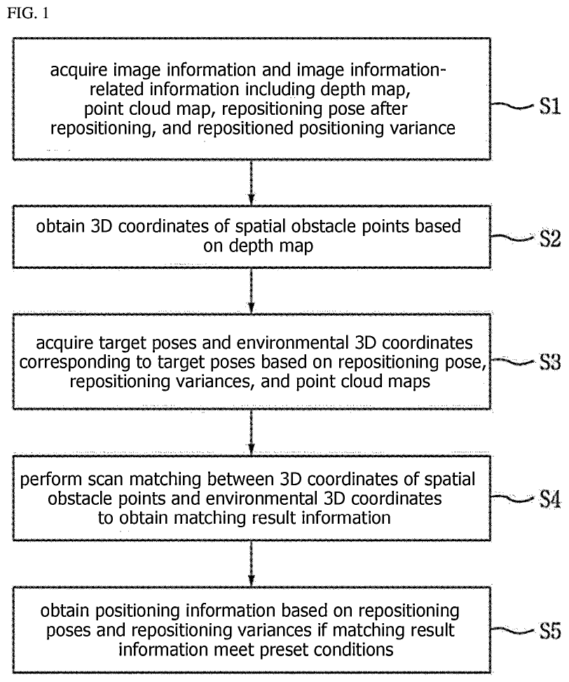

### MODE FOR INVENTION

Hereinafter, a description is made of the 3D sub-grid map-based robot pose estimation method and robot using the same in detail with reference to accompanying drawings.

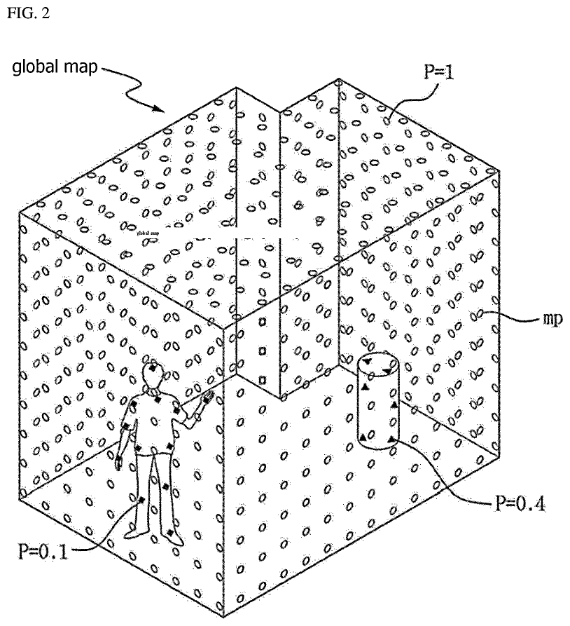

For a clear understanding, the following terms used throughout this invention are defined first. FIG. 2 is a conceptual diagram of a global map used in this invention, which is defined as a collection of ‘spatial coordinates of LiDAR scan data’ with an associated probability (p) of each LiDAR scan data being caused by a static obstacle (mp, hereinafter referred to as a ‘map point’), i.e., (x, y, z, p) sets (x, y, and z represent the spatial coordinates of the LiDAR scan data, and p represents the probability that the spatial coordinates are due to static obstacles detected by the LiDAR). According to the present invention, the robot acquires reflected scan data from surrounding objects using LiDAR, allowing determination of the 3D spatial coordinates of the reflecting objects and assignment of a probability to each coordinate, based on whether the coordinates are likely originated from a static or dynamic obstacle. For example, a point ∘ corresponding to a stationary wall may be assigned a value of 1, a point ▾ corresponding to a chair may be assigned a value of 0.4, and a point ♦ corresponding to a person may be assigned a value of 0.1. In other words, in the present invention, the global map is prepared in advance and is known to the robot. The global map with probabilities assigned to static obstacles may be constructed in the form of a point cloud data (PCD) map, as disclosed in another patent application of the applicant, invention patent 10-2517351, which determines whether reflection points are caused by dynamic or static obstacles and assigns higher probabilities to reflection points with a higher likelihood of being static obstacles.

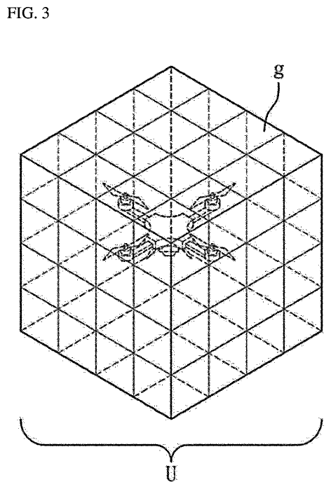

FIG. 3 is a conceptual diagram of a 3D sub-grid map.

A 3D sub-grid map may be defined as a 3D surrounding space including the robot, divided into a plurality of spaces (hereinafter referred to as “sub-grids”) in the horizontal, vertical, and depth directions, and may be defined as a collection of cuboid or rectangular spaces (U). For example, when the robot is a drone, a 3D sub-grid map may be represented by a 10 m-sided hexahedron (U), with 1 m-sided hexahedrons (g) arranged in stacks of 5 m in the front-back, left-right, and up-down directions centered around the drone (the figure is simplified to 4×4×4 form in FIG. 3 to avoid the complexity of the drawing).

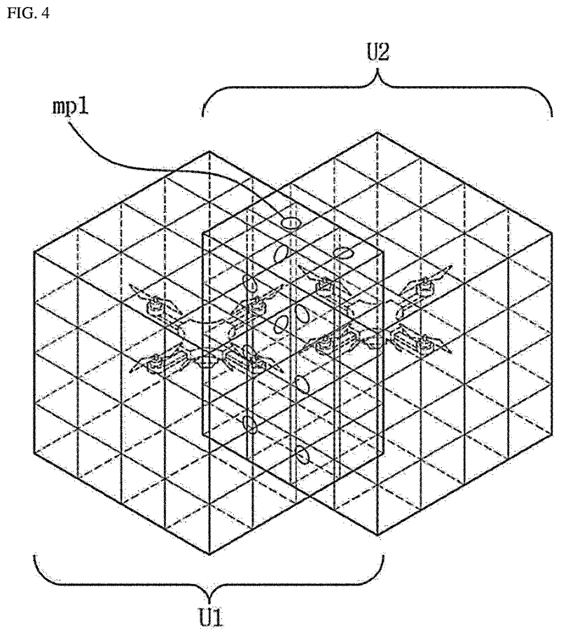

The 3D sub-grid map is redefined when the robot moves a predetermined distance, and it may be desirable for the center of the redefined 3D sub-grid map (U2) to be within the previous 3D sub-grid map (U1), such that the previous 3D sub-grid map (U1) and the redefined 3D sub-grid map (U2) overlap as shown in FIG. 4. This is because including some of the map points (mp1) from the previous 3D sub-grid map in the redefined 3D sub-grid map may improve the accuracy of robot pose estimation.

In this invention, posture is defined as the position and Rodrigues rotation of the robot or particle (hereinafter referred to as “robot, etc.”). In other words, posture consists of the 3D spatial coordinates and rotation components of the robot, etc., which may be represented as a vector (x, y, z, X, Ψ, Ω).

Another important reason for posture in this invention is that when LiDAR scan data acquired from the robot needs to be transformed into data in the global coordinate system, assuming the acquired data as particles representing possible positions of the robot, it requires a translation by the positional differences (Δx, Δy, Δz) between the robot and the particles followed by a 3D rotational transformation by the Rodrigues rotation differences (ΔX, ΔΨ, ΔΩ) between the robot and the particles. A detailed description thereof is made hereinafter in association with the transformation of LiDAR scan data.

In a 3D sub-grid map, each sub-grid is assigned a probability value, which may be determined based on the probabilities of the map points in the global map that fall within the corresponding sub-grid. For example, the probability value may be the average, maximum, or mode (hereinafter referred to as the ‘representative probability’) of the probabilities of the map points included in the corresponding sub-grid. For example, assuming that a specific sub-grid in the 3D sub-grid map contains five map points with probabilities of 1, 1, 1, 0.5, and 0.5 respectively, one of the average value of 0.8, the maximum value of 1, or the mode of 1 may be assigned to that specific sub-grid. The choice of which representative probability value to assign to a sub-grid may be determined by the usage environment of the robot, such as how frequently and how many dynamic obstacles exist in the global map. Alternatively, it may also be possible to calculate all of the average, maximum, and mode and assign the one with the highest estimated accuracy among them as the representative probability value.

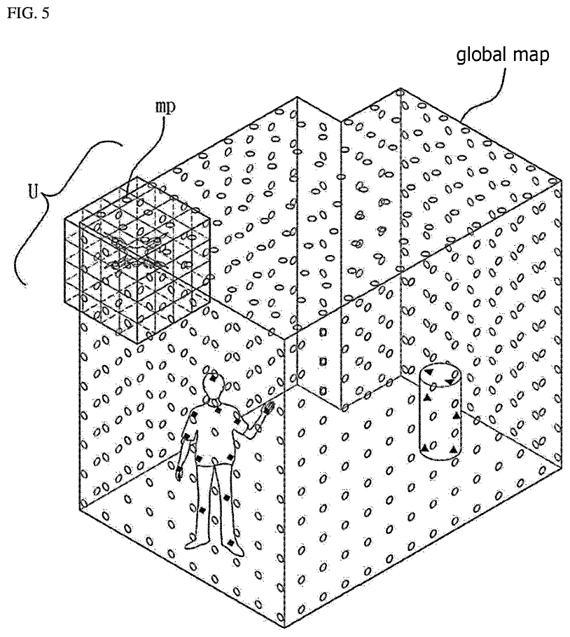

FIG. 5 illustrates the overlapping of a global map and a 3D sub-grid map.

When the robot is located in the middle of the global map and there are no map points included in the 3D sub-grid map, the probability assigned to all sub-grids of the 3D sub-grid map becomes 0, rendering the robot unable to estimate its pose due to isotropy in all directions. Pose estimation becomes possible only after the 3D sub-grid map incorporates map points, which requires the robot to move according to specific criteria or in a random direction. That is, as shown in FIG. 5, the 3D sub-grid map needs to include some of the map points from the global map in order to estimate the pose.

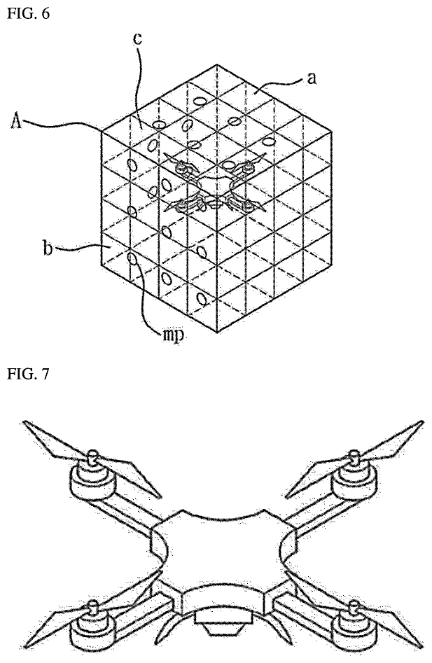

In FIG. 6 illustrating the 3D sub-grid map including map points for the scenario of FIG. 5, it can be observed that the sub-grids ‘a,’ ‘b,’ and ‘c’ forming three sides adjacent to the vertex ‘A’ of the hexahedron contain map points (mp). As described above, pose estimation becomes possible only after map points are included in the 3D sub-grid map like this.

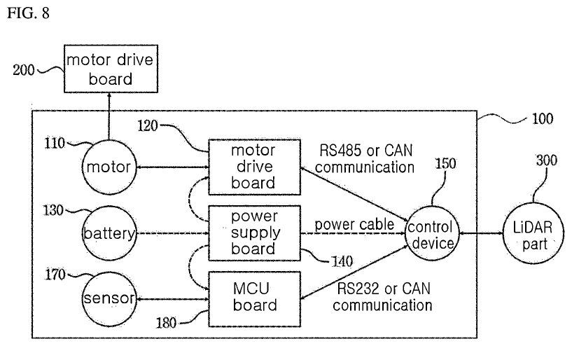

FIG. 7 is a perspective view of a robot capable of pose estimation using a 3D sub-grid map according to the present invention, and FIG. 8 is a block diagram of a robot capable of pose estimation using a 3D sub-grid map according to the present invention.

Although depicted as a drone in FIG. 7, the robot may represent devices such as robotic vacuum cleaners or transporters that move on the ground using wheels or caterpillars.

With reference to FIG. 8, a robot capable of pose estimation using the 3D sub-grid map according to the present invention may include a main body part 100, a transfer part 200 for moving the main body part 100, and a LiDAR part 300 equipped on the main body part 100.

When the LiDAR part 300 detects walls or obstacles in 3D space and generates 3D LiDAR scan data, the main body part 100 compares the LiDAR scan data with the global map to estimate the pose, and the transfer part 200 may move the main body part 100 according to control commands.

The main body part 100 is a component that estimates its pose in real-time within the global space. The global space refers to the space in which the robot moves, utilizing the 3D sub-grid map derived from LiDAR scan data collected by the LiDAR part 300. Examples of the global space may include the interior of a logistics warehouse, the interior of factory, or a parking lot. The global map may be a representation of the global space in PCD map format.

The transfer part 200 may include wheels, endless tracks, and propellers. The transfer part 200 is a component that moves the main body part 100 according to the control of the main body part 100.

The LiDAR part 300 emits light and detects reflected light from objects in the global space, transmitting this information to the main body part 100, and may generate 3D LiDAR scan data using the reflected light from objects such as walls or obstacles.

The main body part 100 may include a motor 110 generating motion necessary for the movement of the robot such as wheels, endless tracks, or propellers, a motor drive board 120 controlling the motor 110, a battery 130, a power supply board 140 controlling the battery, and a control device 150 estimating the pose of the mobile robot based on the LiDAR scan data received from the LiDAR part 300. The control device and its components may include one or more processors/microprocessors combined with computer-readable recording media storing code/algorithms/software readable by a computer. For example, the control device 150 may be a microcomputer or a personal computer (PC).

The main body part 100 may further include a sensors 170, such as infrared sensors and ultrasonic sensors, and a microcontroller unit (MCU) board 180 for collecting data sensed by the sensors 170. The control device 150, motor drive board 120, and MCU board 180 may exchange data and commands using methods such as RS232 or CAN communication.

The control device 150 processes LiDAR scan data to estimate the pose of the robot, and this estimation may be performed in firmware or software. In this invention the concept of a “module” (which is implemented either hardware-wise or software-wise, but are considered equivalent in terms of technical concepts, hence not distinguished) is used to represent both hardware and software implementations, disregarding the distinction between firmware and software.

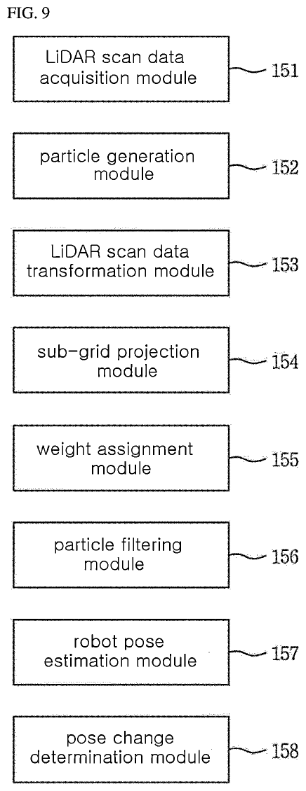

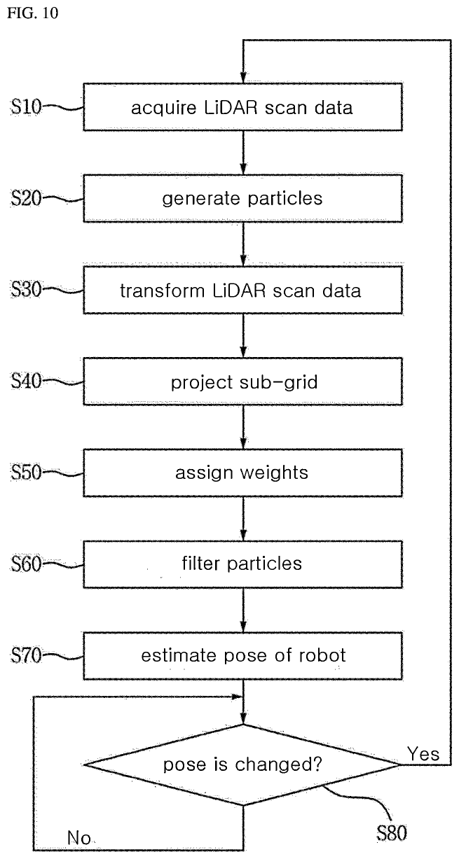

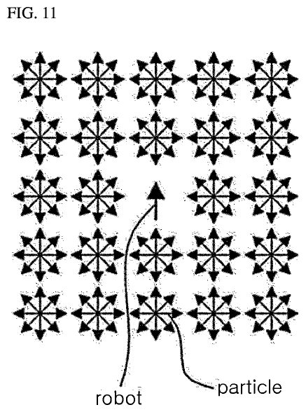

FIG. 9 is a block diagram of a module assembly for estimating the pose of a robot on a PC, and FIG. 10 is a flowchart of a pose estimation method performed in each module. FIG. 10 also serves as a flowchart of the pose estimation method for a robot using the 3D sub-grid map according to the present invention.

In the present invention, the control device 150 may include a LiDAR scan data acquisition module 151, a particle generation module 152, a LiDAR scan data transformation module 153, a sub-grid projection module 154, a weight assignment module 155, a particle filtering module 156, a robot pose estimation module 157, and a pose change determination module 158.

The LiDAR scan data acquisition module 151 is a component acquiring, at step S10, the LiDAR scan data for each sub-grid of the 3D sub-grid map based on the position of the robot, which results in LiDAR scan data as in FIG. 6 when the robot is positioned in the global space as shown in FIG. 5. That is, LiDAR scan data is acquired only for obstacles in the global space that fall within the 3D sub-grid, excluding directions without obstacles (like the right, bottom, and back sides in FIG. 6).

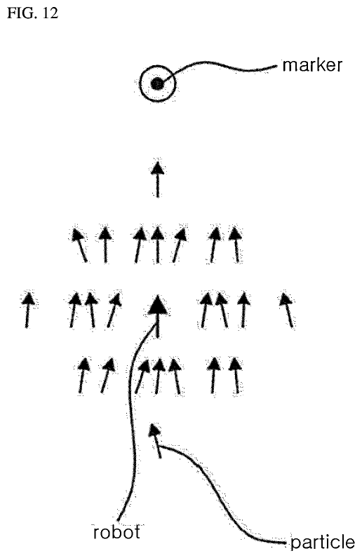

The particle generation module 152 is a component generating robot candidate particles on the global map at step S20. Since the particles are candidates for the robot, each particle is assigned a pose consisting of position and orientation components. In the absence of prior information, particle poses are assigned as shown in FIG. 11 (illustrated in 2D for clarity because distinguishing which particle belongs to which sub-grid becomes challenging in 3D representation; the principle remains the same for both 2D and 3D), including the first generated particle ‘1’. The reason the arrows point in eight directions is to ensure the poses are uniformly distributed for both position and rotation. In actual implementation, the number of arrows may exceed eight to achieve uniform distribution across the global space, which ensures that the probability of the robot occupying any particular particle pose is considered equal.

The ‘1’ at the center in FIG. 11 represents the robot, though not explicitly illustrated to avoid complexity, particles may still be generated at this location. Comparing the transformed LiDAR scan data and global map based on particles reveals an uneven particle distribution, which will be described in detail below.

When the robot has prior information that allows the robot to know the initial pose thereof, such as recognizing or detecting markers, the initially generated particles may be unevenly distributed, as shown in FIG. 12, with a Gaussian distribution centered around the initial robot pose. This means that particles that are more likely to represent the robot's pose may be generated from the outset.

The LiDAR scan data transformation module 153 is a component transforming, at step S30, the LiDAR scan data acquired by the LiDAR scan data acquisition module 151 based on the robot's pose, to the pose of particles generated by the particle generation module 152. This means that the transformation (translation and 3D rotation) of the robot's pose to the pose of the particles is used to determine where the LiDAR scan data observed by the robot is moved to in the global coordinate system by the same transformation.

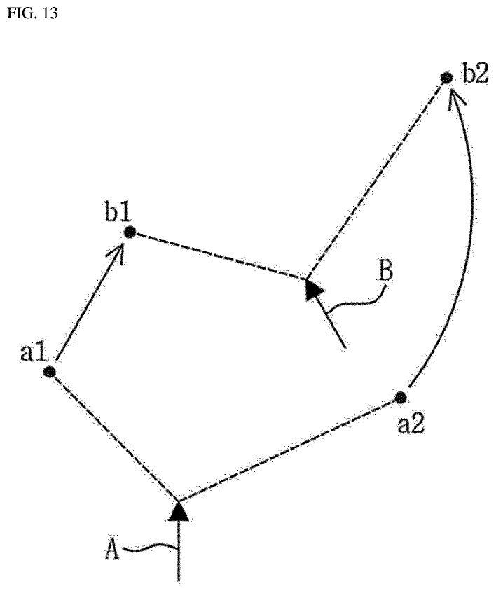

For example, as shown in FIG. 13, when the robot's pose is A, the particle's pose is B, and the LiDAR scan data obtained from the robot is a1 and a2, applying the same translation and 3D rotation transformation that aligns the robot's pose A with the particle's pose B to the LiDAR scan data a1 and a2 results in b1 and b2, which are the transformed LiDAR scan data obtained at step S30.

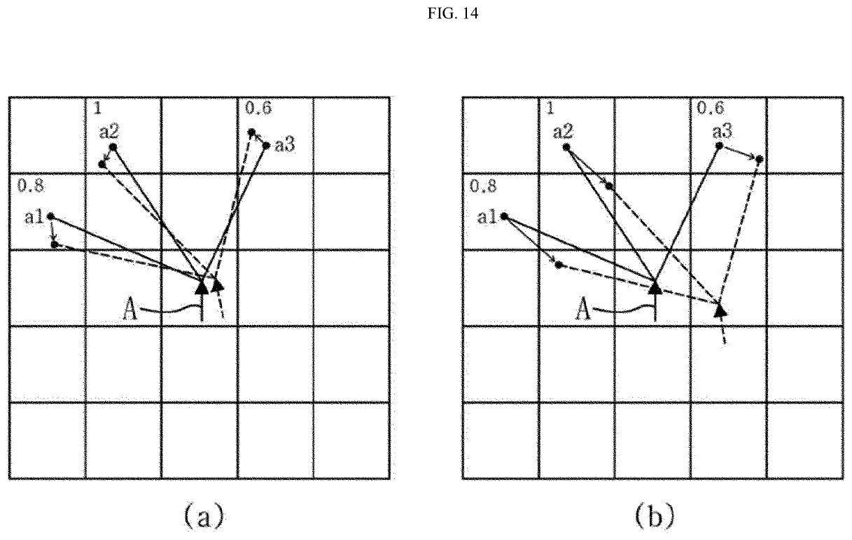

Comparing the LiDAR scan data based on the robot and the transformed LiDAR scan data based on the particles in a 1:1 ratio requires too much computation, so it is necessary to reduce this to a 3D sub-grid dimension. The sub-grid projection module 154 is a component displaying, at step S40, the transformed LiDAR scan data (coordinates) derived from the LiDAR scan data transformed at step S30 onto a 3D sub-grid based on the robot. FIG. 14 illustrates sub-grid projection, where the sub-grid formed based on the robot assigns static obstacle probabilities as shown in the top-left corner.

In FIG. 14, (a) illustrates cases where the robot and particle poses are similar, resulting in the LiDAR scan data and transformed LiDAR scan data occupying the same 3D sub-grid, while (b) illustrates cases where the robot and particle poses differ significantly, causing the LiDAR scan data and transformed LiDAR scan data failing to occupy different sub-grids.

By performing LiDAR scans on 3D sub-grids centered around the robot and comparing the transformed LiDAR scan data with the LiDAR scan data on a sub-grid basis, the computational load is significantly reduced compared to conventional scan matching, enabling real-time pose estimation over a large area.

The weight assignment module 155 is a component assigning, at step S50, weights proportional to the similarity between the pose of each particle and the pose of the robot, and the weight assigned to each particle may be derived from a weight function based on the probability of static obstacles assigned to 3D sub-grids where both LiDAR scan data and transformed LiDAR scan data belong simultaneously or the number of 3D sub-grids where both LiDAR scan data and transformed LiDAR scan data belong simultaneously. The weight function may be designed in various ways, for example, using, as the weight, the sum of the probabilities of static obstacles assigned to 3D sub-grids where both LiDAR scan data and transformed LiDAR scan data belong simultaneously, the maximum probability of static obstacles assigned to 3D sub-grids where both LiDAR scan data and transformed LiDAR scan data belong simultaneously, the average probability of static obstacles assigned to 3D sub-grids where both LiDAR scan data and transformed LiDAR scan data belong simultaneously, the trimmed average of static obstacles assigned to 3D sub-grids where both LiDAR scan data and transformed LiDAR scan data belong simultaneously excluding the maximum and minimum values, or the number of 3D sub-grids where both LiDAR scan data and transformed LiDAR scan data belong simultaneously.

For example, when the sum of probabilities is used as the weight function, particle overlaps with probabilities of 1, 0.8, and 0.6 in 3 sub-grids based on the robot's 3D sub-grid representation in (a) of FIG. 14, resulting in a weight of 2.4, while particle overlaps with a probability of 0.6 in 1 sub-grid in (b) of FIG. 14, resulting in a weight of 0.6.

Particles with poses closer to the robot's pose are assigned higher weights because the transformed LiDAR data is more likely to occupy the same 3D sub-grids as the original data due to minimal transformation. The weights derived in this manner serve as the basis for particle survival (retention).

The particle filtering module 156 is a component filtering particles, at step S60, to retain a predetermined number or proportion of particles, among the particles generated by the particle generation module 152, based on the weights assigned by the weight assignment module 155, in the descending order of weights assigned to each particle by the weight assignment module 155. For example, it may be possible to generate 100 particles and retain only the top 10 particles based on their weights in descending order, or to generate N particles and retain only 0.1 N particles with the highest weights in descending order. Since particle filtering prioritizes particles with high weights, the filtered particles are more likely to be the robot's pose.

The robot pose estimation module 157 is a component estimating, at step S70, the robot's pose based on the poses of filtered particles from the particle filtering module 156, employing methods like averaging particle poses, for example.

The pose change determination module 158 is a component determining at step S80 whether the robot's pose has changed significantly enough to require pose re-estimation. When there's no change in the robot's pose after estimation by the robot pose estimation module 157, there's no need to continue estimating the robot's pose. Robot pose re-estimation is only required when there is a significant change in the robot's pose (e.g., when pose changes or 3D rotational changes exceed a predetermined threshold), and the estimation involves the above described operations of LiDAR scan data acquisition at step S10, particle generation at step S20, LiDAR scan data transformation at step S30, sub-grid projection at step S40, weight assignment at step S50, particle filtering at step S60, and robot pose estimation at step S70. In this invention, the routine from LiDAR scan data acquisition at step S10 to robot pose estimation at step S70 repeats whenever there is a change in the robot's pose. In real-world robotic implementations, pose changes may be determined based on factors such as the rotation of wheels or caterpillars in the transfer part 200 or changes in gyroscope readings.

Once robot pose estimation is complete, particle generation for the next routine may be performed by adding random noise to each pose component (x, y, z, X, Ψ, Ω) of the estimated robot pose, similar to the process described in the particle generation module 152 with prior information.

The robot's pose in the global map may be estimated by referencing (vectorially summing) the pose of the 3D sub-grid map relative to (based on) the origin of the global map (as the coordinate axes of the 3D sub-grid map can be defined by translation and rotation relative to the origin and axes of the global map, the same representation as the pose used in this invention can be applied) and the estimated pose of the robot relative to the origin of the 3D sub-grid map.

DESCRIPTION OF REFERENCE NUMERALS

| | |
|---|---|
| 100: main body part | 110: motor |
| 120: motor drive board | 130: battery |
| 140: power supply board | 150: PC |
| 151: LiDAR scan data acquisition | |
| module | |
| 152: particle generation module | |
| 153: LiDAR scan data transformation | |
| module | |
| 154: sub-grid projection module | |
| 155: weight assignment module | 156: particle filtering module |
| 157: robot pose estimation module | |
| 158: pose change determination module | |
| 170: sensor | 180: MCU board |
| 200: transfer part | 300: LiDAR part |
| S10: LiDAR scan data acquisition step | S20: particle generation step |
| S30: LiDAR scan data transformation | S40: sub-grid projection step |
| step | |
| S50: weight assignment step | S60: particle filtering step |
| S70: robot pose estimation step | S80: pose change determination |
| | step |

1. A robot estimating the pose thereof using a 3-dimensional (3D) sub-grid map, the robot comprising:
a main body part comprising a control device configured to estimate position and orientation;
a transfer part configured to move the main body under the control of the main body part; and
a light detection and ranging (LiDAR) part configured to emit light and detect reflected light from objects in a global space to generate and transmit LiDAR scan data to the main body part;
wherein the control device comprises:
a LiDAR scan data acquisition module configured to acquire LiDAR scan data for each sub-grid of a 3D grid map based on the robot;
a particle generation module configured to generate robot candidate particles on the global map;
a LiDAR scan data transformation module configured to transform the LiDAR scan data acquired by the LiDAR scan data acquisition module based on the pose of the robot to the pose of particles generated by the particle generation module; and
a sub-grid projection module configured to display the transformed LiDAR scan data from the LiDAR scan data transformation module onto the 3D sub-grid based on the robot.

2. The robot of claim 1, wherein the control device further comprises a weight assignment module configured to assign weight proportional to the similarity between the pose of each particle and the pose of the robot.

3. The robot of claim 2, wherein the control device further comprises a particle filtering module configured to retain a predetermined number or proportion of particles, among the particles generated by the particle generation module, based on the weights assigned by the weight assignment module.

4. The robot of claim 3, wherein the control device further comprises a robot pose estimation module configured to estimate the pose of the robot based on the poses of the filtered particles from the particle filtering module.

5. The robot of claim 4, wherein the control device further comprises a pose change determination module configured to determine whether the pose of the robot has changed, triggering a re-estimation the pose of the robot.

6. The robot of claim 5, wherein upon the pose change determination module determining a change in the pose of the robot, the LiDAR scan data acquisition module, particle generation module, LiDAR scan data transformation module, sub-grid projection module, weight assignment module, particle filtering module, and robot pose estimation module repeat the respective operations thereof.

7. The robot of claim 5, wherein upon the LiDAR scan data falling within the 3D sub-grids based on the robot, each sub-grid is assigned a probability indicating the likelihood that the LiDAR scan data represents a static obstacle.

8. The robot of claim 7, wherein the weight assignment module calculates the weights using a weight function based on the probabilities assigned to the sub-grids where both the LiDAR scan data and transformed LiDAR scan data belong simultaneously.

9. The robot of claim 8, wherein the weight function is the sum of the probabilities assigned the 3D sub-grids wherein the LiDAR scan data and transformed LiDAR scan data belong simultaneously.

10. A 3-dimensional (3D) sub-grid map-based pose estimation method, the method comprising:
acquiring LiDAR scan data for each sub-grid of a 3D grid map based on the robot;
generating robot candidate particles on the global map;
transforming the LiDAR scan data acquired by the LiDAR scan data acquisition module based on the pose of the robot to the pose of particles generated by the particle generation module; and
displaying the transformed LiDAR scan data from the LiDAR scan data transformation module onto the 3D sub-grid based on the robot.

11. The method of claim 10, further comprising assigning weight proportional to the similarity between the pose of each particle and the pose of the robot.

12. The method of claim 11, further comprising retaining a predetermined number or proportion of particles, among the particles generated by the particle generation module, through filtering based on the weights assigned by the weight assignment module.

13. The method of claim 12, further comprising re-estimating the pose of the robot based on the poses of the filtered particles from the particle filtering module, and determining whether the pose of the robot has changed, triggering a re-estimation the pose of the robot.

14. The method of claim 13, further comprising, upon determining a change in the pose of the robot, repeating acquiring LiDAR scan data, generating robot candidate particles, transforming the LiDAR scan data, displaying the transformed LiDAR scan data, assigning weight, retaining a predetermined number or proportion of particles through filtering, and estimating the pose of the robot.

15. The method of claim 14, wherein the 3D sub-grid map is redefined when the robot moves a predetermined distance, and the center of the redefined 3D sub-grid map (U2) belongs to the previous 3D sub-grid map (U1), causing an overlap between the previous 3D sub-grid map (U1) and the redefined 3D sub-grid map (U2).

16. The method of claim 15, wherein the pose of the robot in the global map is estimated by referencing the pose of the 3D sub-grid map relative to the origin of the global map and the estimated pose of the robot relative to the origin of the 3D sub-grid map.
